(19) United States
(12) Patent Application Publication
(10) Pub. No.: US 2010/0150069 A1
(43) Pub. Date: Jun. 17, 2010

(54) Reverse Link Acknowledgment Signaling

(75) Inventors: Yonggang Fang, San Diego, CA (US); Yu Xin, Shenzhen (CN); Xiaowu Zhao, Shenzhen (CN)

Correspondence Address: FISH & RICHARDSON, PC, P.O. BOX 1022, MINNEAPOLIS, MN, 55440-1022, US

(73) Assignee: ZTE (USA) INC., Iselin, NJ (US)

(21) Appl. No.: 12/604,330

(22) Filed: Oct. 22, 2009

Related U.S. Application Data
(60) Provisional application No. 61/107,662, filed on Oct. 22, 2008.
(60) Provisional application No. 61/119,101, filed on Dec. 2, 2008.
(60) Provisional application No. 61/147,703, filed on Jan. 27, 2009.

(51) Int. Cl. H04W 40/00

(52) U.S. Cl. 370/328

(57) ABSTRACT

Techniques, apparatuses, and systems can include mechanisms for transmitting and receiving data on one or more reverse link acknowledgement channels.

### PRIORITY CLAIM AND CROSS REFERENCE TO RELATED APPLICATIONS

This document claims the benefit of the priority of U.S. Provisional Application Ser. No. 61/107,662, filed Oct. 22, 2008 and entitled “Reverse Link Acknowledgment Signaling” and claims the benefit of the priority of U.S. Provisional Application Ser. No. 61/119,101, filed Dec. 2, 2008 and entitled “Reverse Link Acknowledgment Signaling” and claims the benefit of the priority of U.S. Provisional Application Ser. No. 61/147,703, filed Jan. 27, 2009 and entitled “Reverse Link Acknowledgment Transmission Mechanism.” The entire contents of all of the above identified documents are incorporated by reference as part of the disclosure of the this document.

### BACKGROUND

This document relates to wireless communications.

Wireless communication systems can include a network of one or more base stations to communicate with one or more wireless devices such as a mobile device, cell phone, wireless card, mobile station (MS), user equipment (UE), access terminal (AT), or subscriber station (SS). Each base station can emit radio signals that carry data such as voice data and other data content to wireless devices. A base station can be referred to as an access point (AP) or can be included as part of an access network (AN).

Radio stations such as wireless devices and base stations can use one or more different wireless technologies for communications. Various wireless technologies examples include Code division Multiple Access (CDMA) such as CDMA2000 1x and its enhancement networks, High Rate Packet Data (HRPD), Universal Mobile Telecommunications System (UMTS), High Speed Packet Access (HSPA), Long-Term Evolution (LTE), and Worldwide Interoperability for Microwave Access (WiMAX).

Some wireless technologies can specify a minimum transmission unit in the physical layer as being one frame. In some wireless technologies, the duration of a frame is 20 ms. For example, a base station can transmit user data in a frame over a forward link fundamental channel (F-FCH) based on a fixed modulation rate such as 9,600 kbps. A mobile station can use a baseband receiver to receive a signal from a base station.

### SUMMARY

This document describes technologies, among other things, for wireless communications including transmitting and receiving reverse link acknowledgment indications.

Techniques for wireless communications can include operating a reverse link, for communications between a mobile station and multiple base stations; receiving data on one or more forward link traffic channels from at least one of the base stations; and transmitting one or more acknowledgment indications on a reverse link acknowledgment channel in response to receiving data on one or more of the forward link traffic channels. Other implementations can include corresponding systems, apparatus, and computer programs, configured to perform the actions of the techniques, encoded on computer readable mediums.

These and other implementations can include one or more of the following features. Receiving data on one or more forward link traffic channels can include receiving data on a forward link fundamental traffic channel from at least one of the base stations. Transmitting one or more acknowledgment indications can include transmitting a first acknowledgment indication on a first reverse link acknowledgment channel in response to receiving data on the forward link fundamental traffic channel from at least one of the base stations. Implementations can include repeating the transmission of the first acknowledgment indication until no traffic data is received on the forward link fundamental traffic channel from the base stations. Implementations can include causing a base station to stop transmission on a forward link fundamental traffic channel after receiving an acknowledgment indication on the first reverse link acknowledgment channel.

Receiving data on one or more forward link traffic channels can include receiving data on a forward link supplemental traffic channel from at least one of the base stations. Transmitting one or more acknowledgment indications can include transmitting a second acknowledgment indication on a second reverse link acknowledgment channel in response to reception of data on the forward link supplemental traffic channel from at least one of the base stations. Implementations can include repeating the transmission of the second acknowledgment indication until no traffic data is received on the forward link supplemental traffic channel from the base stations. Implementations can include causing a base station to stop transmission on a forward link supplemental traffic channel after receiving an acknowledgment indication on the second reverse link acknowledgment channel.

In another aspect, techniques for wireless communications can include operating a reverse link, for communications between a mobile station and a plurality of base stations; receiving data on one or more forward link traffic channels from at least one of the base stations; and transmitting one or more acknowledgment indications on a reverse link acknowledgment channel in response to receiving data on one or more of the forward link traffic channels. Transmitting the one or more acknowledgment indications can include boosting a transmit power associated with the transmission of the one or more acknowledgment indications. Other implementations can include corresponding systems, apparatus, and computer programs, configured to perform the actions of the techniques, encoded on computer readable mediums.

These and other implementations can include one or more of the following features. Receiving data on one or more forward link traffic channels can include receiving data on a forward link fundamental traffic channel from at least one of the base stations. Transmitting one or more acknowledgment indications can include transmitting a first acknowledgment indication on a first reverse link acknowledgment channel in response to receiving data on the forward link fundamental traffic channel from at least one of the base stations. Transmitting one or more acknowledgment indications can include transmitting the first acknowledgment indication with boosted transmit power on the first reverse link acknowledgment channel when a mobile station responds to receiving data on the forward link fundamental traffic channel from more than one base stations.

Receiving data on one or more forward link traffic channels can include receiving data on a forward link supplemental traffic channel from at least one of the base stations. Transmitting one or more acknowledgment indications can include transmitting a second acknowledgment indication on a second reverse link acknowledgment channel in response to reception of data on the forward link supplemental traffic channel from at least one of the base stations. Transmitting one or more acknowledgment indications can include transmitting the second acknowledgment indication with boosted transmit power on the second reverse link acknowledgment channel when a mobile station responds to receiving data on the forward link supplemental traffic channel from more than one base stations.

Implementations can include measuring pilot strength difference between the strongest and the weakest pilots in an active set. Implementations can include transmitting the acknowledgment indication with boosted transmit power based on the measured pilot strength difference between the strongest and the weakest pilots in the active set. Implementations can include causing a base station to stop transmission on a forward link traffic channel after receiving an acknowledgment indication. Implementations can include causing a operating base station to stop transmission on a forward link fundamental traffic channel based on the base station receiving an acknowledgment indication on a first reverse link acknowledgment channel. Implementations can include causing the operating base station to stop transmission on a forward link supplemental traffic channel based on the base station receiving an acknowledgment indication on a second reverse link acknowledgment channel. Transmitting one or more acknowledgment indications can include using a Walsh code channel to transmit the one or more acknowledgment indication. The Walsh code channel can be different from a Walsh code channel assigned to a reverse link power control channel. Implementations can include transmitting power control information on a reverse link power control channel to one or more of the base stations. Transmitting one or more acknowledgment indications can include puncturing the reverse link power control channel with the one or more acknowledgment indications.

In another aspect, techniques for wireless communications can include receiving wireless signals that include a traffic packet from multiple base stations via a forward link traffic channel, each base station repeatedly transmitting the traffic packet in multiple slots of a frame within ones respective wireless signal. Such techniques can include transmitting, based on a successful receipt of the traffic packet, an acknowledgment indication to the base stations via a reverse link acknowledgement channel to cause one or more of the base stations to cease transmission of the traffic packet for a remainder of the frame. Such techniques can include selectively transmitting, based on receiving an additional transmission of the traffic packet from at least one of the base stations, one or more additional acknowledgment indications via the reverse link acknowledgement channel. Other implementations can include corresponding systems, apparatus, and computer programs, configured to perform the actions of the techniques, encoded on computer readable mediums.

In another aspect, techniques for wireless communications can include receiving wireless signals that include a traffic packet from multiple base stations via a forward link traffic channel, each base station repeatedly transmitting the traffic packet in multiple slots of a frame within ones respective wireless signal; measuring pilot signal strengths of the base stations, respectively; determining an output power for a reverse link acknowledgement channel based on the measured pilot signal strengths; and transmitting, based on a successful receipt of the traffic packet and the determined output power, an acknowledgment indication to the base stations via the reverse link acknowledgement channel to cause the base stations to cease transmission of the traffic packet for a remainder of the frame. Other implementations can include corresponding systems, apparatus, and computer programs, configured to perform the actions of the techniques, encoded on computer readable mediums.

Techniques for transmitting a reverse link acknowledgment indication can include operating a mobile station to transmit sequential multiple reverse link acknowledgement signals to multiple base stations in a soft handoff. Other techniques can include operating a mobile station to transmit a single acknowledgement signal over reverse link code channel with a transmit power boost to cause multiple base stations to successfully receive the acknowledgement in the soft handoff. Some techniques can include operating a mobile station to make forward link pilot strength measurements for base stations associated with the mobile station's soft handoff to dynamically adjust the transmission power boost level of the mobile station's reverse link acknowledgement signal. Other implementations can include corresponding systems, apparatus, and computer programs, configured to perform the actions of the techniques, encoded on computer readable mediums.

These and other implementations can include one or more of the following features. Implementations can include operating a first reverse link code channel and a second reverse link code channel for communications to a base station, operating the reverse link code channels can include multiplexing the first and second reverse link channels using respective first and second communication codes; receiving data on first and second forward channels from the base station; and transmitting acknowledgment indications on the first reverse channel and the second reverse channel using the respective first and second communication codes. A mobile station can use multiple techniques for transmitting acknowledgment indications to response to base station communications such as ones received on forward fundamental and supplemental channels.

A system for wireless data communication can include one or more base stations and one or more mobile stations. The base stations and mobile stations can be configured to perform operations that include one or more techniques or variations of techniques described herein.

In another aspect, systems for wireless communications can include multiple base stations configured to communicate with a mobile station during a handoff. Each base station can be configured to perform operations that include: transmitting a traffic packet in a first slot of a frame to the mobile station; monitoring a reverse link acknowledgement channel for an acknowledgment indication from the mobile station, wherein the acknowledgment indication signals a successful receipt of the traffic packet by the mobile station; selectively transmitting the traffic packet in a second slot of the frame based on an absence of the acknowledgment indication in the monitoring; and ceasing the transmission of the traffic packet in a remaining one or more slots of the frame based on a receipt of the acknowledgment indication.

Particular implementations of the subject matter described in this document can be implemented to realize one or more of the following potential advantages. Increasing the reliability of a reverse link signal that includes an acknowledgment indication can increase the likelihood that a base station successfully receives the acknowledgment indication. Successfully receiving the acknowledgment indication can cause the base station to cease a transmission of a traffic packet to a mobile station, which can increase the overall system capacity. Boosting transmitting power of the acknowledgement signal over the reverse link code channel can assist base stations, such as base stations in a soft handoff for a mobile station, to receive an acknowledgement reliably so that the forward link transmission can be terminated properly; which can increase forward link capacity when the base station stops transmitting specified data. Repeating the transmitting of an acknowledgment indication over a reverse link code channel can similarly assist base stations to receive an acknowledgement reliably. R-ACK signaling, such as transmitting an acknowledgement indication, can result in earlier termination of traffic on a forward link traffic channel and can increase system capacity.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1A shows an example of a wireless communication network in a soft handoff scenario.

FIG. 1B shows an example of a wireless communication network with multiple base stations.

FIG. 2 shows an example of a radio station architecture.

FIG. 3A shows an example of transmitting an acknowledgment indication punctured in a reverse link pilot channel.

FIG. 3B shows an example of transmitting multiple acknowledgment indications punctured in a reverse link pilot channel.

FIG. 4A shows an example of a puncturing architecture for including one or more acknowledgement indications in a forward fundamental channel.

FIG. 4B shows an example of a mechanism to communicate acknowledgment indications for respective supplemental channels.

FIG. 4C shows an example of a technique for transmitting an acknowledgment indication punctured in a reverse link pilot channel.

FIG. 5 shows an example of transmitting an acknowledgment indication over a Walsh code channel to a single base station.

FIG. 6 shows an example of transmitting acknowledgment indications over a Walsh code channel to multiple base stations.

FIG. 7 shows an example of transmitting an acknowledgment indication over a Walsh code channel to multiple base stations using a transmission power boost.

FIGS. 8A and 8B show different examples of acknowledgment indication transmission techniques.

Like reference symbols in the various drawings indicate like elements.

### DETAILED DESCRIPTION

Various wireless technologies use one or more power control mechanisms to regulate transmit power on communications between base stations and mobile stations. Power control mechanisms can adaptively adjust transmit power to reduce interference to other wireless communications, which can increase the communication capacity of a wireless communication system. A base station can use a power control mechanism to control its transmit power level in one or more power control group (PCG) intervals based on feedback information from one or more mobile stations. In some implementations, a PCG interval duration is equal to 1/16 of the duration of a physical frame. A mobile station can provide power control feedback via a Power Control Bit (PCB) in a reverse link signal transmission. A base station can receive a PCB indication and can adjust its transmit power based on the received PCB indication.

A physical frame layout can be partitioned into slots to provide a finer granularity to make power control adjustments. A physical frame layout can include multiple slots, with each slot being a minimum transmission unit instead of a frame. In some implementations, a physical frame layout can include multiple slots that correspond to PCG intervals. For example, a physical frame layout can include 16 slots to correspond to 16 PCG intervals.

A base station can transmit identical information, such as identical traffic packets, in multiple slots of a frame over a forward link traffic channel such as a forward link fundamental traffic channel (F-FCH) or a supplement traffic channel (F-SCH). A mobile station can progressively accumulate such a forward link signal, slot by slot, until an associated signal strength is strong enough for demodulation and decoding. If the mobile station can successfully demodulate and decode the traffic packet, the mobile station can send an acknowledgement indication such as a reverse link acknowledgement (R-ACK) to indicate the success. During a transmission of a frame, the base station can transmit slot data repeatedly until the base station receives and processes an R-ACK associated with the frame. Stopping the transmission before the end of the frame can save transmit power, can reduce forward link interference, and can increase communication capacity.

Various wireless technologies provide different handoff mechanism such ones for softer handoff, soft handoff, and hard handoff to facilitate a handoff between different base stations in providing smooth and continuous wireless service to a wireless device. In a soft handoff, multiple base stations can transmit the same traffic packet to a mobile station. The mobile station can combine signals, e.g., soft combining of signals, for packet demodulation and decoding which may result in greater a signal sensitivity and increased likelihood of a successful demodulation and decoding of a traffic packet. Therefore, a wireless communication system may operate the base stations to transmit weaker signals for demodulating and decoding the frames in a mobile station capable of combining base station signals. A reduction in signal strength can reduce interference generated from base stations when the mobile station is in a handoff region, and can improve overall system capacity.

During a soft handoff, multiple base stations can receive a mobile station's reverse link signal. The baseband receivers of the respective base stations can be in different hardware modules and/or different locations. Therefore, it may be difficult to use a mechanism similar to a soft combining mechanism as used by the mobile station for combining forward link traffic packets. In some wireless communication systems, base stations can forward reverse link signal data to a selection function such as one implemented in a Base Station Controller (BSC). A selection function selects the best reverse traffic signal data as received by respective multiple base stations. The selected reverse traffic data can be forwarded to a core network via a Packet Data Serving Node (PDSN). In some implementations, there is no need to forward reverse link packets from more than one different base station to the core network.

The reverse link signaling demodulation and decoding, however, is different from the traffic data selection. Base stations can demodulate and decode the reverse link signal, e.g., R-ACK signal, at baseband level, and can process the information content therein once decoding is completed. Process the information content at a BS has the potential advantage of reducing latency, because the BS does not have to transmit the R-ACK signaling information to a BSC and, then, wait for the BSC to make a decision. In some cases, using a selection function to assist in demodulation and decoding of an R-ACK signal from a mobile station may add a long processing delay and might be not feasible. In some implementations, R-ACK reverse link signaling is required to be received and processed at each base station so that the base station can take proper action such as early termination of forward link transmission. Using a selection function without additional mechanisms may cause not solve the problem of missing a R-ACK, and accordingly, may cause the base station to continue to transmit the traffic packet. Failing to stop the transmission may result in a waste system of system capacity.

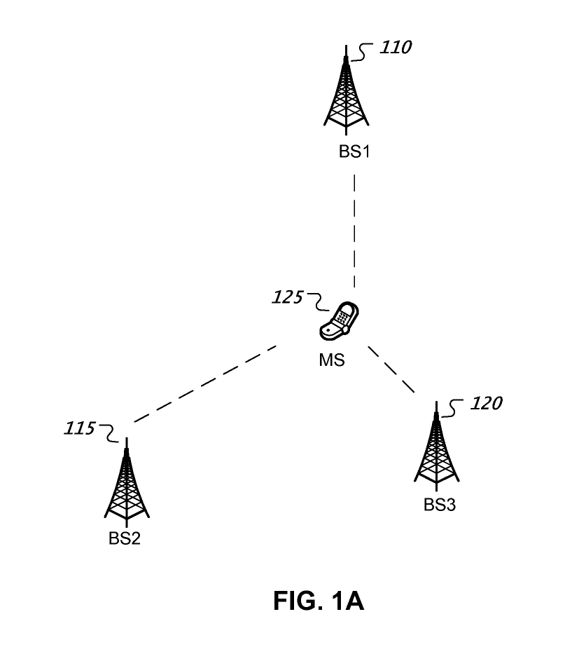

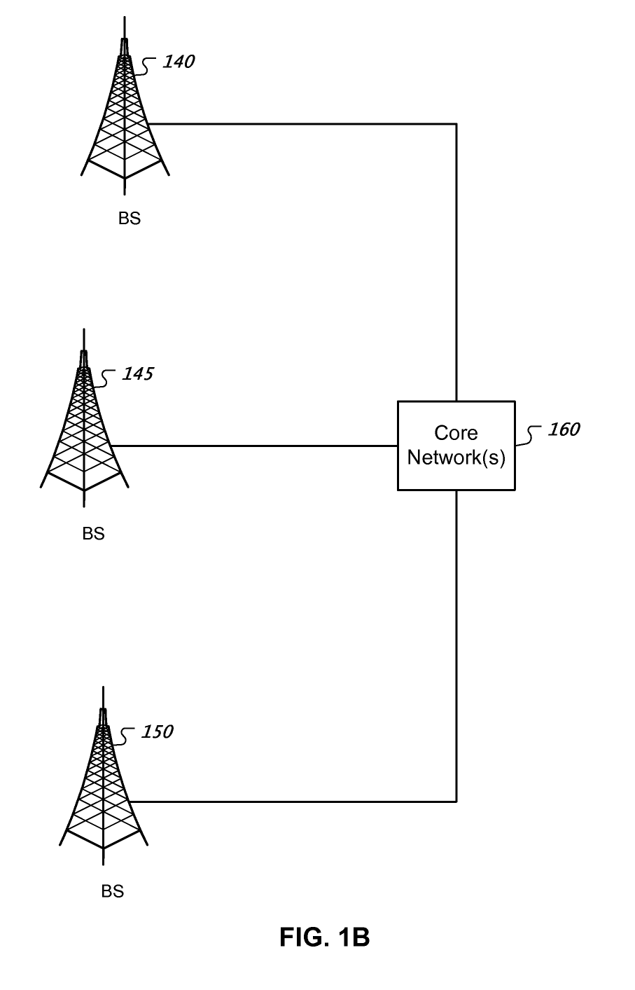

FIG. 1A shows an example of a wireless communication network in a soft handoff scenario. A wireless communication network can include multiple base stations 110, 115, 120 distributed over a geographical area to provide wireless service to wireless devices, such as a mobile station 125. A mobile station 125 can receive one or more signals from different base stations 110, 115, 120. Moreover, a mobile station 125 can move around in the geographical area and can switch between different base stations 110, 115, 120 based on measurements of base station signals. In the soft handoff scenario, multiple neighboring base stations 110, 115, 120 can transmit the same packet over their respective forward link traffic channels to a mobile station 125. The mobile station 125 can include a baseband receiver that combines the signals from different base stations 110, 115, 120 before demodulation and decoding. Based on successfully receiving data from one or more of the base stations 110, 115, 120, a mobile station 125 can transmits R-ACK information to one or more base stations 110, 115, 120 using a R-ACK transmission mechanism.

In an air link connection without soft handoff, a base station controller can use a outer loop reverse link power control mechanism to set a frame error rate to within a certain level, e.g., setting point. When the base station controller measures the frame error rate to be higher than a threshold for the traffic channel, the base station controller can adjust the setting point. The base station can measure the mobile station's pilot transmit power, compare with the setting point, and perform the inner loop power control. Measuring the mobile station's pilot transmit power can include measuring a Signal to Interference-plus-Noise Ratio (SINR). If the base station detects the received pilot's SINR from the mobile station is less than the setting point, the base station can send a PCB of 0 to request the mobile station to increase its transmission power so that more frames can be demodulated and decoded correctly by the base station.

When a mobile station is in a soft handoff scenario, multiple base stations may receive a reverse link signal from the mobile station. Each base station can apply the reverse link power control mechanism to attempt to maintain the frame error at a given rate. However, base stations may have different receiving conditions. For example, the reverse link signal may be stronger at some base stations and weaker for other base stations. Hence, some base stations may or may not have sufficient SINR, which may cause the base stations to send different power control commands such as different PCB values to the mobile station. When the mobile station receives opposing PCBs, the mobile station can follow a pre-defined algorithm to reduce the transmission power unless all of the PCBs from the base stations request to increase the transmission power. In some case, the power control mechanism may result in only one base station, in a soft handoff, to successfully receive a reverse link traffic channel. This may be acceptable for the reverse link traffic data because a BSC selection function selects the best reverse link signal data and forward to the core network. However, for the reserve link signaling such as R-ACK signaling, base stations need to be able to successfully receive an R-ACK transmission to terminate its forward link traffic packet transmission. A failure to terminate such a transmission can reduce overall system capacity

This document includes examples and implementations details of R-ACK transmission mechanisms for the reliable delivery of R-ACKs to base stations. Various examples of R-ACK transmission mechanisms include mechanisms for transmitting R-ACK information shared with a reverse link pilot channel (R-PICH) and mechanisms for transmitting R-ACK information in a reverse acknowledgement code channel. In some implementations, mechanisms for transmitting R-ACK information can include repeating transmission of R-ACK information. In some implementations, mechanisms for transmitting R-ACK information can include boosting power for a transmission of R-ACK information.

FIG. 1B shows an example of a wireless communication network with multiple base stations. A wireless communication network can include one or more base stations (BSs) 140, 145, 150 to provide wireless service to wireless devices. A base station 140, 145, 150 can transmit a signal on a forward link (FL), or called a downlink (DL), to one or more wireless devices. A wireless device can transmit a signal on a reverse link (RL), or called an uplink (UL), to one or more base stations 140, 145, 150. For example, a base station 140, 145, 150 can transmit data to a wireless device via one or more traffic channels, e.g., forward link fundamental channel (F-FCH), first forward link supplemental channel (F-SCH1), and second forward link supplemental channel (F-SCH2).

A wireless communication network can include one or more core networks 160 to control one or more base stations 140, 145, 150. Examples of wireless communication networks that can implement the present techniques and systems include, among others, wireless communication networks based on Code division Multiple Access (CDMA) and its enhancement networks. Some wireless communication networks can use one or more of the following to communicate: CDMA2000 1x, High Rate Packet Data (HRPD), Long-Term Evolution (LTE), Universal Terrestrial Radio Access Network (UTRAN), Universal Mobile Telecommunications System (UMTS), and Worldwide Interoperability for Microwave Access (WiMAX).

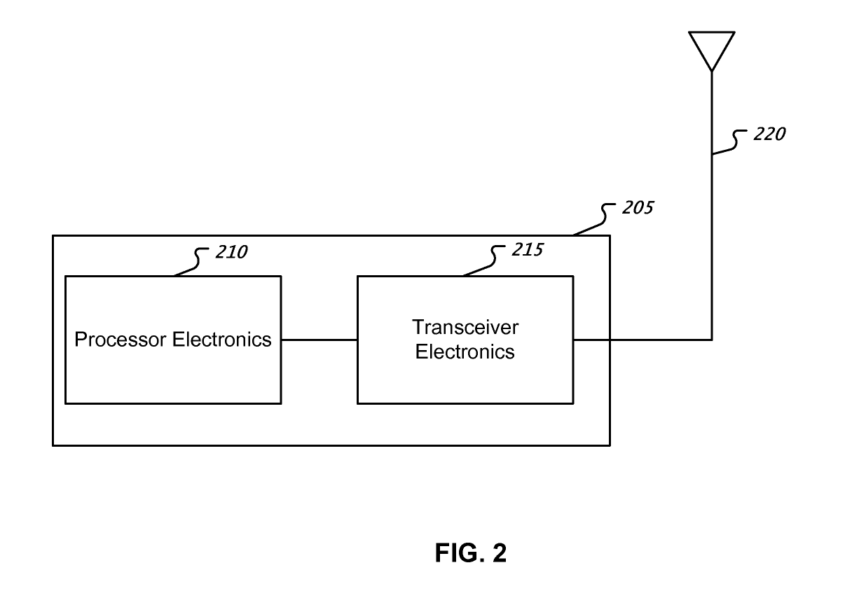

FIG. 2 shows an example of a radio station architecture for use in a wireless communication network. A radio station 205 such as a base station or a mobile station can include processor electronics 210 such as a microprocessor that implements methods such as one or more of the techniques described herein. Wireless station 205 can include transceiver electronics 215 to send and/or receive wireless signals over a communication interface such as antenna 220. Radio station 205 can include other communication interfaces for transmitting and receiving data.

In some implementations, a mobile station can multiplex reverse link acknowledgment indication data onto an existing reverse link channel. For example, a mobile station can include a R-ACK for a F-FCH packet acknowledgment in the reverse link pilot channel (R-PICH). A specific position or slot in a R-PICH frame, e.g., the second last quarter power control group (PCG), can be reserved for an acknowledgment indication. In some implementations, this specific slot is different from the slot(s) reserved for R-PCB (power control bits). Upon successfully decoding forward link traffic sent from a base station, such as traffic on F-FCH, the mobile station can send a R-ACK indication punctured in a specific R-ACK slot of pilot channel in the next PCG. Otherwise, this specific slot would not be punctured and could still be used to transmit a pilot signal for use by the base station to demodulate reverse link traffic from the mobile station. The mobile station can repeatedly transmit an R-ACK indication if the BS does not stop sending traffic packet over F-FCH.

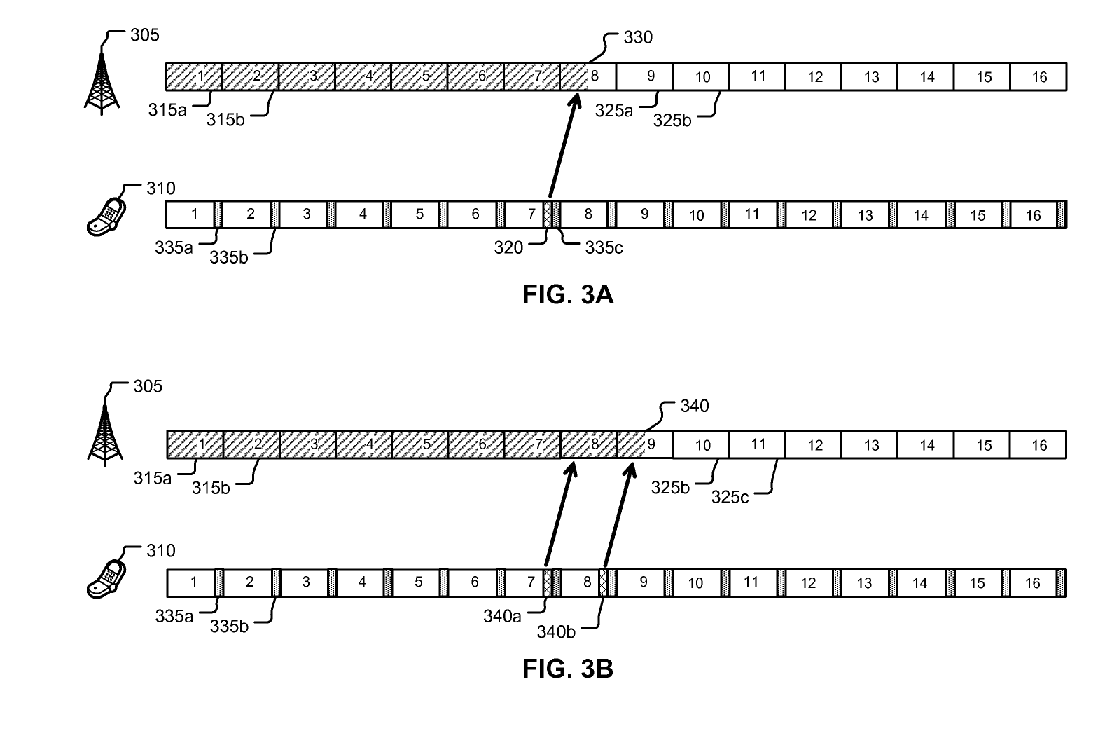

FIG. 3A shows an example of transmitting an acknowledgment indication punctured in a reverse link pilot channel. A base station 305 can transmit information to one or more mobile stations 310 based on a frame layout that includes 16 slots. A mobile station 310 can operate a R-PICH to assist a radio station such as a base station 305 to receive data transmitted by the mobile station 310.

A base station 305 can selectively transmit data in one or more slots 315a, 315b of a frame. For example, a base station 305 can transmit the same traffic packet in multiple slots 315a, 315b of a frame. The base station 305 can cease transmission of the traffic packet in one or more slots 325a, 325b, of the frame based on information received from a mobile station 310.

A mobile station 310 can transmit an acknowledgment indication 320 to the base station 305 based on successfully receiving a forward link traffic packet. In some implementations, a mobile station 310 can use information received in multiple slots 315a, 315b to demodulate and decode a traffic packet. The mobile station 310 can transmit the acknowledgment indication 320 by puncturing a specific slot of R-PICH with the acknowledgment indication 320. For example, the mobile station 310 transmits the acknowledgement indication 320 by puncturing the R-PICH with the acknowledgement indication 320. In some implementations, the mobile station 310 can transmit power control information such as a PCB bit 335a, 335b, 335c on a R-PICH. An acknowledgment indication 320 can be adjacent to a PCB bit 335c.

Based on successfully receiving the acknowledgment indication 320, the base station 305 can cease to transmit the traffic packet in the remaining slots 325a, 325b of the frame. In some cases, the base station 305 can cease a transmission of a traffic packet within a slot 330 based on successfully receiving the acknowledgment indication 320. In some implementations, a base station 305 can transmit a signal in one or more PCGs, e.g., PCG 1 to PCG 16, on a F-FCH. Based on receiving reverse link data over PCGs from the base station 305, a mobile station 310 can transmit an acknowledgment indication 320.

FIG. 3B shows an example of transmitting multiple acknowledgment indications punctured in a reverse link pilot channel. In some cases, a base station 305 may not be able to successfully receive an acknowledgment indication 340a from a mobile station 310. Therefore, in some implementations, a mobile station 310 can transmit one or more additional acknowledgment indications 340b. In some implementations, the mobile station 310 can repeatedly puncture a R-PICH with acknowledgment indications 340a, 340b.

Based on successfully receiving the additional acknowledgment indication 340b, the base station 305 can cease to transmit the traffic packet in the remaining slots 325b, 325c of the frame. Based on timing, the base station 305 can cease a transmission of a traffic packet in a slot 340 that is already in progress. Based on observing that the base station 305 has ceased transmitting the traffic packet, the mobile station 310 can cease to transmit acknowledgment indications for the remainder of the frame.

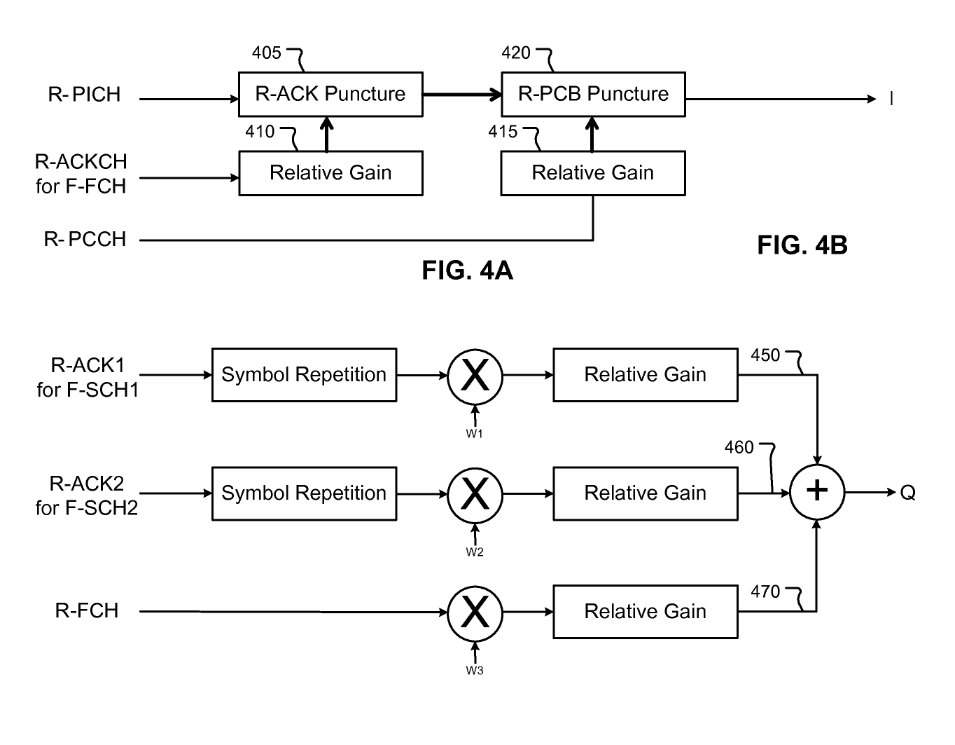

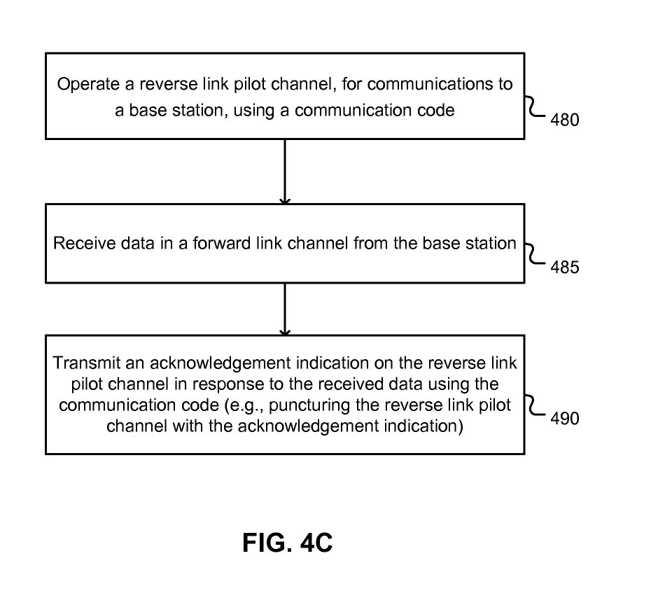

FIG. 4A shows an example of a puncturing architecture for including one or more acknowledgement indications in a forward fundamental channel. In this example, R-ACK and R-PCB are punctured on the R-PICH in different positions in a frame. A mobile station can include a R-ACK puncture mechanism 405 that punctures a R-PICH with one or more R-ACKs with relative gain 410 based on an output of a reverse link acknowledgement channel (R-ACKCH). A mobile station can include a R-PCB puncture mechanism 420 that punctures a R-PICH with one or more R-PCBs with relative gain 415 based on an output of a reverse link power control channel (R-PCCH).

FIG. 4B shows an example of a mechanism to communicate acknowledgment indications for respective forward supplemental channels. A mobile station can receive data from a base station over multiple supplemental channels, e.g., F-SCH1 and F-SCH2. The mobile station can generate acknowledgment indications for respective supplemental channels. For example, the mobile station can use channels R-ACK1 and R-ACK2 to acknowledge F-SCH1 and F-SCH2 traffic respectively. A mobile station can use a first Walsh code, e.g., W1, to multiplex R-ACK1 traffic associated with F-SCH1. The mobile station can use a second, different, Walsh code, e.g., W2, to multiplex R-ACK2 traffic associated with F-SCH2. The mobile station can use a third Walsh code, e.g., W3, to multiplex R-FCH. The mobile station can combine the output of these three multiplexing stages 450, 460, 470 to produce a transmission signal.

FIG. 4C shows an example of a technique for transmitting an acknowledgment indication punctured in a reverse link pilot channel. Such a technique can include operating a reverse link pilot channel, for communications to a base station, using a communication code, e.g., Walsh code (480); receiving data in a forward link channel from the base station (485); and transmitting an acknowledgment indication punctured on the reverse link pilot channel in response to the received data using the communication code (490). Transmitting the acknowledgment indication in a reverse link pilot channel can include puncturing the reverse link pilot channel with the acknowledgment indication. In some implementations, technique for transmitting an acknowledgment indication can include using a CDMA based wireless protocol.

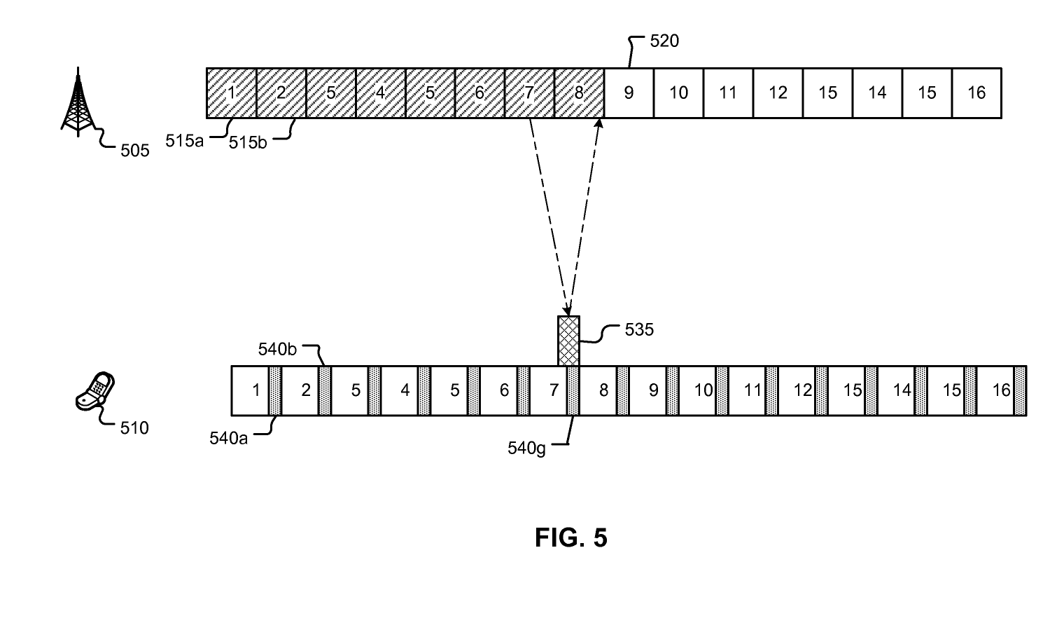

FIG. 5 shows an example of transmitting an acknowledgment indication over a Walsh code channel to a single base station. A base station 505 and a mobile station 510 can be in a soft handoff scenario where the number of soft handoff connections equals one. A base station 505 can transmit a traffic packet over a channel such as F-FCH or F-SCH in one or more slots 515a, 515b of a 16-slot frame. In some implementations, each slot 515a, 515b associated with the traffic packet carries identical information.

A mobile station 510 can monitor forward link traffic slots 515a, 515b to receive data sent from the base station 505. Based on successfully receiving a traffic packet, e.g., demodulating and decoding the traffic packet in slot #7, the mobile station 510 can send a reverse link acknowledgement indication 535 to the base station 505. In some implementations, a mobile station 510 can modulate the acknowledgement indication 535 on a Walsh code channel of a reverse link slot, e.g., slot #7. In some implementations, the mobile station 510 uses a Walsh code channel for the acknowledgement indication 535. Once the base station 505 receives the acknowledgement indication 535, e.g., receiving the indication within slot #8, the base station 505 can stop the current forward transmission and switch to discontinue transmission (DTX) on the forward link traffic channel starting at the next slot, e.g., slot #9.

In some implementations, a mobile station 510 can transmit PCB information, e.g., a PCB 540a, 540b, 540g for each slot of a frame, over a R-PICH. In some implementations, an acknowledgement indication 535 transmission can be aligned with a PCB transmission 540g.

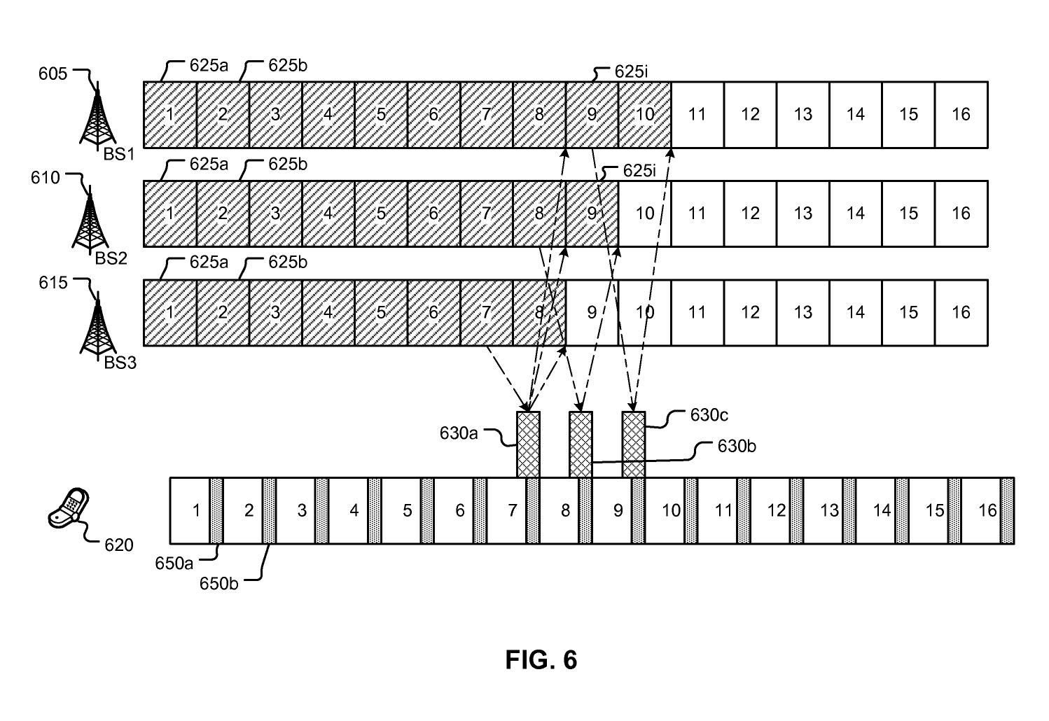

FIG. 6 shows an example of transmitting acknowledgment indications over a Walsh code channel to multiple base stations. Multiple base stations BS1 (605), BS2 (610), BS3 (615) and a mobile station 620 can be in a soft handoff scenario, where the number of soft handoff connections is greater than one. In this example, multiple base stations 605, 610, 615 transmit identical traffic packets over a channel such as a F-FCH in one or more slots 625a, 625b of a 16-slot frame to a mobile station 620 during a soft handoff. A base station 605, 610, 615 ceases the transmission based on receiving an acknowledgment indication from the mobile station 620. In some cases, one or more base stations 605, 610, 615 may not be able to successfully receive an initial acknowledgment indication 630a from a mobile station 620. Therefore, in some implementations, a mobile station 620 can transmit additional acknowledgment indications 630b, 630c to the base stations 605, 610, 615.

The mobile station 620 can progressively receive the forward link traffic data from the multiple base stations 605, 610, 615 on a per slot basis. In some implementations, the mobile station 620 can perform soft combining, e.g., maximum ratio combining, on the multiple received signals at baseband. Based on successfully decoding a forward link traffic packet, e.g., at slot #7, the mobile station 620 can send one or more acknowledgment indications 630a, 630b, 630c over a Walsh code channel to the base stations 605, 610, 615 in consecutive slots starting from the slot, e.g., reverse link slot #7, that corresponds to the successfully decoded forward link traffic packet.

When a base station, such as BS3 (615), successfully receives an acknowledgment indication 630a, the base station can cease traffic packet transmission and can switch to DTX on the forward link traffic channel for the remainder of the frame, e.g., starting at slot #9. However, some base stations such as BS1 (605) and BS2 (610) may not have successfully received the acknowledgment indication 630a from the mobile station 620 and can still continue their traffic packet transmissions, e.g., at slot #9 (625i). A demodulation or decoding failure may prevent a base station from successfully receiving data.

The mobile station 620 can continue to monitor forward link traffic after the mobile station 620 has transmitted an acknowledgement indication 630a to detect whether a base station is still transmitting the traffic packet. If the mobile station 620 detects that one or more base station amongst the soft handoff base stations BS1, BS2 or BS3 is still transmitting the forward link packet over the F-FCH, the mobile station 620 can send an additional acknowledgement indication 630b, 630c over the Walsh code channel. The acknowledgement indication 630b, 630c transmissions can continue until the mobile station does not detect forward link traffic from handoff base station(s) or at the end of the frame.

If a base station does not successfully receive an acknowledgement indication, a base station can continue to monitor for acknowledgement indications in the following slot(s). In some implementations, a base station 605, 610 can combine multiple acknowledgement indication transmissions to successfully receive the information content of the acknowledgement indication. For example, a base station 605, 610 can perform a soft combination of signals containing different instances of acknowledgement indications 630a, 630b. If the base station, e.g., BS2, can demodulate and decode the combined transmissions of acknowledgements at slot #9, the base station can stop the traffic packet transmission and can switch to DTX on the forward link traffic channel after slot #9.

In some implementations, a mobile station 620 can transmit an acknowledgement indication 630a, 630b or 630c over a Walsh code channel of the reverse link. In some implementations, a mobile station 620 can transmit PCB information, e.g., a PCB 650a, 650b for each slot of a frame, over a R-PICH. An acknowledgement indication 630a, 630b or 630c transmission can be adjacent to a PCB transmission over R-PICH.

In some implementations, a mobile station can automatically transmit two sequential acknowledgment indications and then cease transmission of the acknowledgment indication for the remainder of the frame. If a base station does not successfully receive the first acknowledgment indication, then the base station can use the second acknowledgment indication in combination with the first one to attempt to demodulate and decode the reverse link signal.

In some implementations, a mobile station can increase a transmission power of an acknowledgment indication code channel to increase the likelihood that the acknowledgment indication transmission will be successfully received by multiple base stations. Determining a power boost amount for an acknowledgment indication transmission can include measuring signal strengths of multiple base stations and computing an acknowledgment indication adjustment gain. In some implementations, an acknowledgment indication adjustment gain is based on pilot strength measurements of signals transmitted by multiple respective base stations.

In some implementations, a mobile station can increase its transmit power of an acknowledgement indication code channel based on the setting value controlled by the base station. The base station can broadcast the boosting values of the reverse link acknowledgement indication transmit power when in different soft handoff cases such as number of handoff links equal to or greater than one.

A mobile station can receive pilot signals from respective base stations during a handoff. In some implementations, a mobile station can use information such as pilot signal strength or SINR measured on the pilots of various base stations to dynamically adjust transmit power boosting for an acknowledgement indication transmission. The mobile station can make a pilot strength measurement on each of the pilot signals. Let Pₓ represent the pilot strength measurement from the x-th base station associated with the handoff. In some implementations, Pₓ can represent an average of multiple pilot strength measurements, e.g., mean input power of a pilot signal.

The mobile station can determine which base station provides the strongest forward link signal as measured by the mobile station. Further, the mobile station can determine which base station provides the weakest forward link signal as measured by the mobile station. Therefore, in some implementations, an acknowledgment indication adjustment gain can be equal to, or proportional to, |Pᵢ−Pⱼ|, where “i” represents the base station that provides the strongest forward link signal as measured by the mobile station and “j” represents the base station that provides the weakest forward link signal measured by the mobile station.

In some cases, the absolute value of the difference between pilot strength measurements may exceeds an upper bound value. In some implementations, an acknowledgment indication adjustment gain can be limited based on an upper bound value, e.g., MAX_GAIN. For example, if |Pᵢ−Pⱼ|>MAX_GAIN, then the acknowledgment indication adjustment gain is equal to MAX_GAIN. Otherwise, if |Pᵢ−Pⱼ|≦MAX_GAIN, then the acknowledgment indication adjustment gain is equal to |Pᵢ−Pⱼ|.

In some implementations, the MAX_GAIN of a reverse link acknowledgement channel can be defined by the access network. For different handoff scenario, such as the number of handoff links is equal to one, or greater than one, the access network can define different boosting power levels, such as MAX_GAIN1 or MAX_GAIN2. The base station can broadcast the reverse link acknowledgement channel gains to the mobile stations. When a mobile station receives the reverse link acknowledgement channel gains over the overhead channel, they can apply the transmit gains to the reverse link acknowledgement channel using the above algorithm in different handoff scenarios. In some implementations, a mobile station can directly apply the received reverse link acknowledgement channel gains (MAX_GAIN1 or MAX_GAIN2) to the R-ACK transmission regardless the pilot measurement result.

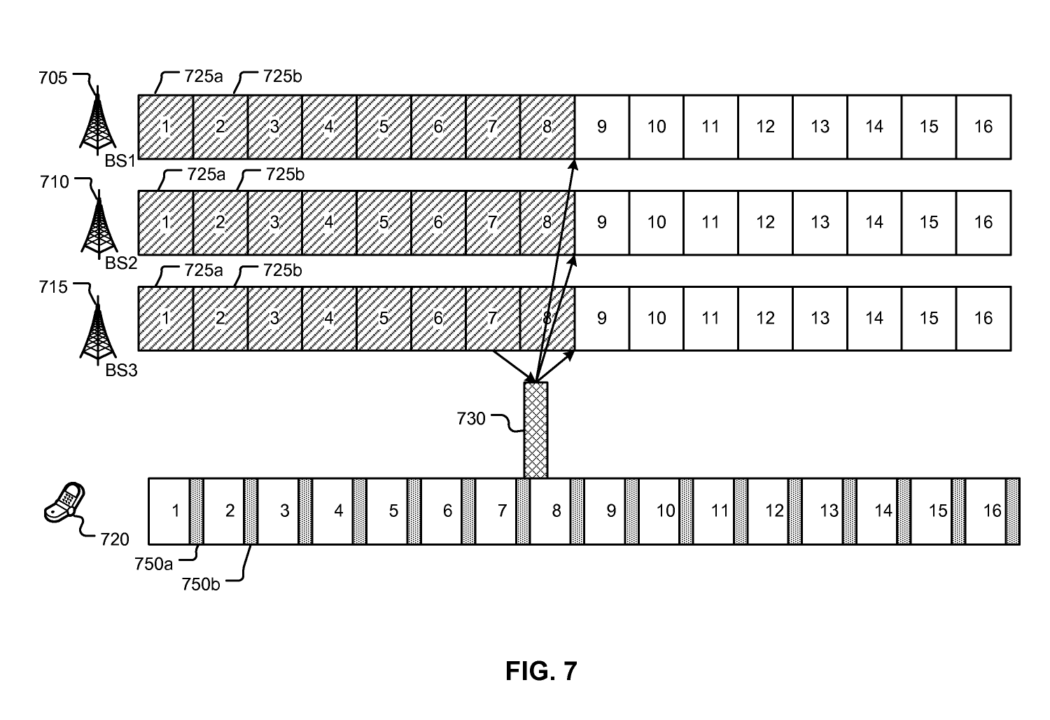

FIG. 7 shows an example of transmitting an acknowledgment indication over a Walsh code channel to multiple base stations using a transmission power boost. Multiple base stations BS1 (705), BS2 (710), BS3 (715) and a mobile station 720 can be in a soft handoff scenario, where the number of soft handoff connections is greater than one. In this example, multiple base stations 705, 710, 715 transmit identical traffic packets over a forward link traffic channel in one or more slots 725a, 725b of a 16-slot frame to a mobile station 720 during a soft handoff. A base station 705, 710, 715 ceases the transmission based on receiving an acknowledgment indication from the mobile station 720. The mobile station 720 can determine a power boost to transmit an acknowledgment indication 730 based on monitoring signal strengths of the respective base stations 705, 710, 715.

The mobile station 720 can progressively receive the forward link traffic data from the multiple base stations 705, 710, 715 on a per slot basis. In some implementations, the mobile station 720 can perform soft combining, e.g., maximum ratio combining, on the multiple received signals at baseband. Based on successfully decoding a forward link traffic packet, e.g., at slot #7, the mobile station 720 can send one acknowledgment indication 730 with a power boost to the base stations 705, 710, 715 in a slot, e.g., reverse link slot #7, that corresponds to the successfully decoded forward link traffic packet. In some implementations, if the mobile station 720 can successfully decode a forward link traffic packet, e.g., at slot #7, the mobile station 720 can immediately send a single acknowledgment indication with power boosting to the base stations 705, 710, 715.

When a base station 705, 710, 715 successfully receives the power boosted acknowledgment indication 730a, the base station 705, 710, 715 can cease traffic packet transmission and can switch to DTX on the forward link traffic channel for the remainder of the frame, e.g., starting at slot #9.

In some implementations, a mobile station 720 can transmit an acknowledgement indication 730 over a Walsh code channel of the reverse link. In some implementations, a mobile station 720 can transmit PCB information, e.g., a PCB 750a, 750b for each slot of a frame, over a R-PICH. An acknowledgement indication 730 transmission can be adjacent to a PCB transmission over R-PICH.

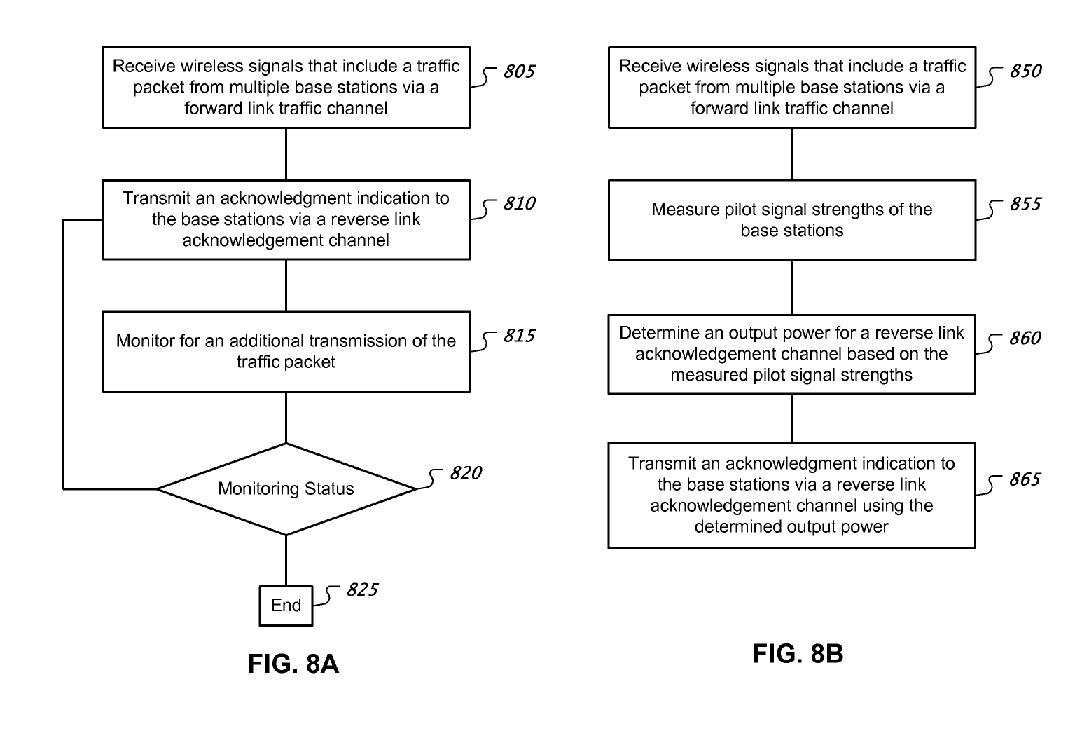

FIG. 8A an example of acknowledgment indication transmission technique. A mobile station can receive wireless signals that include a traffic packet from multiple base stations via a forward link traffic channel (805). Various examples of a forward link traffic channels include a forward link fundamental traffic channel and one or more forward link supplemental traffic channel. In some implementations, each base station repeatedly transmits the traffic packet in multiple slots of a frame in the base station's forward link signal.

Based on a successful receipt of the traffic packet, the mobile station can transmit an acknowledgment indication to the base stations via a reverse link acknowledgement channel to cause one or more of the base stations to cease transmission of the traffic packet for a remainder of the frame (810). The mobile station can monitor for an additional transmission of the traffic packet from the base stations (815). If the monitoring process detects such an additional transmission (820), the mobile station can transmit an additional acknowledgment indication via the reverse link acknowledgment channel. If the monitoring process does not detect an additional transmission during the rest of the frame (820), the monitoring can conclude for the current instant (825).

FIG. 8B shows a different example of acknowledgment indication transmission technique. A mobile station can receive wireless signals that include a traffic packet from multiple base stations via a forward link traffic channel (850). The mobile station can measure pilot signal strengths of the base stations (855). The mobile station can determine an output power for a reverse link acknowledgement channel based on the measured pilot signal strengths (860). Based on a successful receipt of the traffic packet, the mobile station can transmit an acknowledgment indication to the base stations via the reverse link acknowledgement channel using the determined output power (865).

In some implementations, the mobile station can transmit an acknowledgment indication to the base stations directly using the received reverse link acknowledgement channel gains for different soft handoff scenario regardless of the pilot measurement result. In some implementations, the mobile station can transmit a reverse link acknowledgement signal over a reverse link pilot channel to the base stations. In some implementations, the mobile station could transmit the reverse link acknowledgement over a separate Walsh code channel. Some implementations on the described subject matter can combine multiple approaches described herein to provide reliable delivery of R-ACK signals to multiple base stations in the soft handoff scenario.

In some implementations, multiple base stations in a soft handoff can transmit forward link traffic packets over forward link supplemental channels (F-SCHs). A mobile station can send multiple acknowledgement signals over different reverse link code channels to the base stations. Each R-ACK signal corresponding to a specific F-SCH can be transmitted over an individual reverse link code channel.

In some implementations, techniques for transmitting an acknowledgment indication can include operating a reverse link pilot channel, for communications to a base station, using a first communication code; receiving first data in a forward link channel from the base station; and transmitting an acknowledgment indication on the reverse link pilot channel in response to the first data using the first communication code. Transmitting the acknowledgment can include puncturing the reverse link pilot channel with the acknowledgment indication.

In some implementations, techniques, apparatuses, and systems for transmitting an acknowledgment indication can include operating a mobile station to transmit sequential reverse link acknowledgement signals to multiple base stations in a soft handoff scenario. Techniques, apparatuses, and systems can include operating a mobile station to transmit a single acknowledgement indication over a reverse link code channel with transmit power boosting such that the multiple base stations can successfully receive the acknowledgement in a soft hand scenario. A mobile station can use a forward link pilot strength measurement from multiple base stations in a soft handoff to dynamically adjust the transmission power boosting level of a reverse link acknowledgement signal. In some implementations, the output power of the reverse link acknowledgement channel in the soft handoff case is relatively higher than in the non soft handoff case. In some implementation, a mobile station may simply apply the reverse link acknowledgement channel gain received from the base station to the R-ACK transmission regardless the pilot strength measurement.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this patent application in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communications, comprising:
operating a reverse link, for communications between a mobile station and a plurality of base stations;
receiving data on one or more forward link traffic channels from at least one of the base stations; and
transmitting one or more acknowledgment indications on a reverse link acknowledgment channel in response to receiving data on one or more of the forward link traffic channels.

2. The method of claim 1, wherein receiving data on one or more forward link traffic channels includes receiving data on a forward link fundamental traffic channel from at least one of the base stations,
wherein transmitting one or more acknowledgment indications comprises transmitting a first acknowledgment indication on a first reverse link acknowledgment channel in response to receiving data on the forward link fundamental traffic channel from at least one of the base stations.

3. The method of claim 2, further comprising:
repeating the transmission of the first acknowledgment indication until no traffic data is received on the forward link fundamental traffic channel from the base stations.

4. The method of claim 2, further comprising:
causing a base station to stop transmission on the forward link fundamental traffic channel after receiving an acknowledgment indication on the first reverse link acknowledgment channel.

5. The method of claim 2, wherein receiving data on one or more forward link traffic channels includes receiving data on a forward link supplemental traffic channel from at least one of the base stations,
wherein transmitting one or more acknowledgment indications comprises transmitting a second acknowledgment indication on a second reverse link acknowledgment channel in response to receiving data on the forward link supplemental traffic channel from at least one of the base stations.

6. The method of claim 5, further comprising:
repeating the transmission of the second acknowledgment indication until no traffic data is received on the forward link supplemental traffic channel from the base stations.

7. The method of claim 5, further comprising:
causing a base station to stop transmission on the forward link supplemental traffic channel after receiving an acknowledgment indication on the second reverse link acknowledgment channel.

8. A method for wireless communications, comprising:
operating a reverse link, for communications between a mobile station and a plurality of base stations;
receiving data on one or more forward link traffic channels from at least one of the base stations; and
transmitting one or more acknowledgment indications on a reverse link acknowledgment channel in response to receiving data on one or more of the forward link traffic channels, wherein transmitting the one or more acknowledgment indications comprises boosting a transmit power associated with the transmission of the one or more acknowledgment indications.

9. The method of claim 8, wherein receiving data on one or more forward link traffic channels includes receiving data on a forward link fundamental traffic channel from at least one of the base stations,
wherein transmitting one or more acknowledgment indications comprises transmitting a first acknowledgment indication on a first reverse link acknowledgment channel in response to receiving data on the forward link fundamental traffic channel from at least one of the base stations.

10. The method of claim 9, wherein transmitting one or more acknowledgment indications comprises transmitting the first acknowledgment indication with boosted transmit power on the first reverse link acknowledgment channel when a mobile station responds to receiving data on the forward link fundamental traffic channel from more than one base stations.

11. The method of claim 9, wherein receiving data on one or more forward link traffic channels includes receiving data on a forward link supplemental traffic channel from at least one of the base stations,
wherein transmitting one or more acknowledgment indications comprises transmitting a second acknowledgment indication on a second reverse link acknowledgment channel in response to reception of data on the forward link supplemental traffic channel from at least one of the base stations.

12. The method of claim 11, wherein transmitting one or more acknowledgment indications comprises transmitting the second acknowledgment indication with boosted transmit power on the second reverse link acknowledgment channel when a mobile station responds to receiving data on the forward link supplemental traffic channel from more than one base stations.

13. The method of claim 8, further comprising:
measuring pilot strength difference between the strongest and the weakest pilots in an active set.

14. The method of claim 13, wherein transmitting one or more acknowledgment indications comprises transmitting the acknowledgment indication with boosted transmit power based on the measured pilot strength difference between the strongest and the weakest pilots in the active set.

15. The method of claim 8, further comprising:
causing a base station to stop transmission on a forward link traffic channel after receiving an acknowledgment indication.

16. The method of claim 15, further comprising:
causing a operating base station to stop transmission on a forward link fundamental traffic channel based on the base station receiving an acknowledgment indication on a first reverse link acknowledgment channel.

17. The method of claim 16, further comprising:
causing the operating base station to stop transmission on a forward link supplemental traffic channel based on the base station receiving an acknowledgment indication on a second reverse link acknowledgment channel.

18. The method of claim 8, wherein transmitting one or more acknowledgment indications comprises using a Walsh code channel to transmit the acknowledgment indication.

19. The method of claim 8, wherein the Walsh code channel is different from a Walsh code channel assigned to a reverse link power control channel.

20. The method of claim 8, further comprising:
transmitting power control information on a reverse link power control channel to one or more of the base stations,
wherein transmitting one or more acknowledgment indications comprises puncturing the reverse link power control channel with the one or more acknowledgment indications.

21. A method for wireless communications, comprising:
receiving wireless signals that include a traffic packet from multiple base stations via a forward link traffic channel, each base station repeatedly transmitting the traffic packet in multiple slots of a frame within ones respective wireless signal;
transmitting, based on a successful receipt of the traffic packet, an acknowledgment indication to the base stations via a reverse link acknowledgement channel to cause one or more of the base stations to cease transmission of the traffic packet for a remainder of the frame; and
selectively transmitting, based on receiving an additional transmission of the traffic packet from at least one of the base stations, one or more additional acknowledgment indications via the reverse link acknowledgement channel.

22. The method of claim 21, further comprising:
transmitting a first acknowledgment indication on a first reverse link acknowledgement channel based on a successful receipt of a traffic packet via a forward link fundamental traffic channel from at least one of the base stations; and
transmitting a second acknowledgment indication on a second reverse link acknowledgement channel based on a successful receipt of a traffic packet via a forward link supplemental traffic channel from at least one of the base stations.

23. The method of claim 22, further comprising:
repeating the transmission of the first acknowledgment indication until no traffic data is received on the forward link fundamental traffic channel from the base stations.

24. The method of claim 22, further comprising:
repeating the transmission of the second acknowledgment indication until no traffic data is received on the forward link supplemental traffic channel from the base stations.

25. The method of claim 21, wherein the forward link traffic channel is a forward link fundamental traffic channel.

26. The method of claim 21, wherein the forward link traffic channel is a forward link supplemental traffic channel.

27. The method of claim 21, further comprising:
transmitting a signal over a reverse link pilot channel to the base stations, wherein the reverse link pilot channel includes the reverse link acknowledgement channel; and
puncturing the reverse link pilot channel to include one or more acknowledgment indications.

28. A method for wireless communications, comprising:
receiving wireless signals that include a traffic packet from multiple base stations via a forward link traffic channel, each base station repeatedly transmitting the traffic packet in multiple slots of a frame within ones respective wireless signal;
measuring pilot signal strengths of the base stations, respectively;
determining an output power for a reverse link acknowledgement channel based on the measured pilot signal strengths; and
transmitting, based on a successful receipt of the traffic packet and the determined output power, an acknowledgment indication to the base stations via the reverse link acknowledgement channel to cause the base stations to cease transmission of the traffic packet for a remainder of the frame.

29. The method of claim 28, further comprising:
transmitting a signal over a reverse link pilot channel to the base stations,
wherein the output power of the reverse link acknowledgement channel is relatively higher than an output power of the reverse link pilot channel.

30. The method of claim 28, wherein transmitting the acknowledgment indication comprises transmitting the acknowledgment indication with boosted transmit power based on a measured pilot strength difference between the strongest and the weakest pilots in a active set.

31. The method of claim 28, further comprising:
transmitting a first acknowledgment indication on a first reverse link acknowledgement channel based on the determined output power and on a successful receipt of a traffic packet via a forward link fundamental traffic channel from at least one of the base stations; and
transmitting a second acknowledgment indication on a second reverse link acknowledgement channel based on the determined output power and on a successful receipt of a traffic packet via a forward link supplemental traffic channel from at least one of the base stations.

32. The method of claim 28, wherein the forward link traffic channel is a forward link fundamental traffic channel.

33. The method of claim 28, wherein the forward link traffic channel is a forward link supplemental traffic channel.

34. A system for wireless communications, comprising:
operating multiple base stations to communicate with a mobile station during a handoff, wherein each base station is configured to perform operations comprising:
transmitting a traffic packet in a first slot of a frame to the mobile station;
monitoring a reverse link acknowledgement channel for an acknowledgment indication from the mobile station, wherein the acknowledgment indication signals a successful receipt of the traffic packet by the mobile station;
selectively transmitting the traffic packet in a second slot of the frame based on an absence of the acknowledgment indication in the monitoring; and
ceasing the transmission of the traffic packet in a remaining one or more slots of the frame based on a receipt of the acknowledgment indication.

35. The system of claim 34, wherein each base station is configured to stop transmission on a forward link fundamental traffic channel after receiving an acknowledgment indication on a first reverse link acknowledgment channel.

36. The system of claim 35, wherein each base station is configured to stop transmission on a forward link supplemental traffic channel after receiving an acknowledgment indication on a second reverse link acknowledgment channel.

37. The system of claim 34, wherein each base station is configured to transmit the traffic packet over a forward link traffic channel and to switch to using a discontinuous transmission on the forward link traffic channel based on receiving the acknowledgment indication.
